(19) United States
(12) Patent Application Publication
(10) Pub. No.: US 2009/0049504 A1
(43) Pub. Date: Feb. 19, 2009

(54) MULTIVIDEO-PURPOSE PORTABLE ELECTRONIC DEVICE

(75) Inventor: RAY L. LU, TAIPEI CITY (TW)

Correspondence Address: ROSENBERG, KLEIN & LEE, 3458 ELLICOTT CENTER DRIVE-SUITE 101, ELLICOTT CITY, MD, 21043, US

(73) Assignee: EGALAX_EMPIA TECHNOLOGY INC., TAIPEI CITY (TW)

(21) Appl. No.: 11/839,851

(22) Filed: Aug. 16, 2007

(51) Int. Cl. H04N 7/16

(52) U.S. Cl. 725/141

(57) ABSTRACT

Described is a multivideo-purpose portable electronic device which is capable of providing TV and PC camera functions, and even a storage function. By using the multivideo-purpose portable electronic device, a user can watch a TV program received externally and get involved in a video conference/chat process concurrently, store the TV program and a content of the video conference/chat process and watch the stored TV program and the content of the video conference/chat process on different computers. In addition, a specific application software necessary for operating the multivideo-purpose portable electronic device on the computer may be directly stored in the multivideo-purpose portable electronic device itself. As such, a promoted convenience and lower cost are achieved.

### BACKGROUND OF THE INVENTION

1. Field of the Invention

The present invention relates to a portable electronic device and particularly to a multivideo-purpose portable electronic device.

2. Description of the Related Art

As the electronic technology greatly proceeds, universal serial bus (USB) interface has been developed for computer, which is an interface for the computer to have a peripheral electronic device or peripheral electronic devices connect thereto and work therewith, so that a specific function or functions can be achieved thereon. The electronic device(s) connecting to the computer is/are equipped with the so-called plug-and-play function and the electronic devices are connected in series in this configuration.

Portable electronic device is one form of the peripheral electronic devices and may be connected to the computer for a specific purpose via one of various kinds of interfaces, particularly the USB interface. The portable electronic device includes, but is not limited to, digital camera, MP3 player, personal digital assistant (PDA), cellular phone, portable digital TV card, one inch mini hard drive, EZ-drive, etc. The content associated with the portable electronic device can be written from or uploaded to the computer connected therewith via the interface therebetween, thereby achieving the specific function.

Since the computer is capable of mass storage and strong data processing, the portable electronic device connected thereto can be benefited with control from the computer when working together therewith. Further, since the portable electronic device can be carried in hand, it has enjoyed a popularity in market. However, there are many kinds of function-specific portable electronic devices. At this time, a user has to pay a high cost and inconvenience if he/she desires to have several kinds of the portable electronic devices.

The followings will be dedicated to introduction of some such portable electronic devices, with reference to FIG. 1 and FIG. 2.

The portable TV card is a device through which the user can watch a TV program on a computer when the portable TV card is connected to the computer. FIG. 1 is a schematic diagram illustrating how the portable TV card works with the computer. As shown, the portable TV card 10 is connected to an external computer 15 and comprises a hybrid TV tuner module 11, a digital demodulation module 12, an analog decoding module 13 and a hybrid TV processing module 14. The hybrid TV processing module 14 comprises a digital processing interface 141, an analog processing interface 142 and a USB interface 143. The computer 15 comprises an application software (not shown) for accessing the portable TV card 10 at least including beginning or stopping a TV program.

When a user plays a TV program on the computer 15 by executing the application software thereon, the hybrid TV tuner module 11 receives a digital TV signal input TV_digital or an analog TV signal input TV_analog. Then, the hybrid TV tuner module 11 outputs a digital video/audio signal IF1 or an analog video signal input IF2 and an analog audio signal SIF. Each of the digital and analog TV signals TV_digital and TV_analog may be one of a wireless TV signal and a cabled TV signal and comprises a video signal and an audio signal.

Next, the digital demodulation module 12 and analog decoding module 13 receive the digital video/audio signal IF1 or the analog video signal IF2 and the analog audio signal SIF, and demodulates the digital video/audio signal IF1 and decodes the analog video signal IF2 and analog audio signal SIF, respectively. Then, the digital demodulation module 12 and analog decoding module 13 output a demodulated digital video/audio signal TS, and a decoded digital video signal YUV and a decoded digital audio signal I²S/AC-Link, respectively. The decoded digital audio signals I²S and AC-Link are taken from two different digital audio signal systems, respectively, and one of which is employed. Thereafter, the digital processing interface 141 and analog processing interface 142 receive the demodulated digital video/audio signal TS, and the decoded digital video signal YUV and decoded digital audio signal I²S/AC-Link, respectively. Then, a computer interface signal CUSB is outputted from the hybrid TV processing module 14 to the computer 15 connected with the portable TV card 10 through the USB interface 143, in response to the received demodulated digital video/audio signal TS and decoded digital video signal YUV and the decoded digital audio signal I²S/AC-Link.

PC camera is a portable electronic device through which a video conference or chat process may be proceeded on a computer connected therewith. FIG. 2 depicts an illustration where the PC camera is connected to a computer and work therewith. As shown, the portable PC camera 20 is connected to an external computer 24 and comprises an video/audio control module 21, a sensing module 22, a lens module 23 and a sound acquiring module 23′. The computer 24 comprises an application software for accessing the PC camera at least including beginning or stopping a video conference or chat process the PC camera 20.

The video/audio control module 21 comprises a video control interface 211, an audio control interface 212 and a USB interface 213. When the user chat process with someone remotely on the computer 24 by performing the application software, the lens module 23 is used to receive an image Image from outside (particularly continuous images) and transmits the received image Image to the sensing module 22. In response, the sensing module 22 converses the received image Image into an electric signal RGB_bayer representing a digital image data, where the digital image data is referred to as a bayer image data, in the format of the conventional RGB image data.

The sound acquiring module 23′ is used to receive a sound Sound from outside, and output an audio signal MIC in response thereto. Then, the digital image data signal RGB_bayer is transmitted to the video/audio control module 21 through the video control interface 211 for further processing in the video/audio control module 21, including a process where the digital data in the image data signal RGB_bayer is conversed into a digital image data in the YUV format. The audio signal MIC is then transmitted to the audio control interface 212 to be processed. Subsequently, the video/audio control module 21 outputs a computer interface signal CUSB to the computer 24 through the USB interface 213. At this time, the portable PC camera 20 may achieve the video and audio recording function in cooperation with the computer 24.

Like other portable electronic devices, the above described portable TV card and portable PC camera device each have its own purpose. Although the portable TV card and the PC camera both are related to video and audio content, they should have their own hardware and software and should be used separately. Or these portable devices may seek a wider range of functions. Therefore, there is a need to provide a multivideo-purpose portable electronic device in which the video and audio content associated with different functions can be integrally processed. Although the audio content is also involved in the multivideo-purpose portable electronic device, the multivideo-purpose portable electronic device is thus termed by considering the TV and PC camera functions provided thereby are conceptually video-oriented.

### SUMMARY OF THE INVENTION

It is, therefore, an object of the present invention to provide a multivideo-purpose portable electronic device, so that the cost thereof can be lowered and user convenience thereof can be enhanced.

In accordance with the present invention, the multivideo-purpose portable electronic device, comprising a sound acquiring module, a TV module, an image acquiring module and a hybrid processing module. The sound acquiring module is used to receive a first sound form outside and outputting an audio signal in response thereto. The TV module comprises a hybrid TV tuner unit, a digital demodulation unit and an analog decoding unit. The hybrid TV tuner unit is used to receive one of an external digital TV signal and an external analog TV signal each comprising a video signal and an audio signal, and outputting one of a digital video/audio signal, and an analog video signal and a second analog audio signal in response thereto. The digital demodulation unit is used to receive the digital video/audio signal and outputting a demodulated digital video/audio signal according thereto. The analog decoding unit is used to receive the analog video signal and first and second audio signals and outputting a decoded digital video signal and a decoded first and second digital audio signal in response thereto. The image acquiring module is used to store a data content and comprises an image acquiring unit acquiring an image and a sensing unit receiving the acquired image and outputting an image signal in response thereto. The hybrid processing module has a digital processing interface receiving the demodulated digital video/audio signal, an analog processing interface receiving the decoded digital video signal and the first and second decoded audio signal, an image processing interface receiving the image signal; and a USB interface connected to an external computer.

In operation, the multi-video/audio purpose portable electronic device is further enabled by a command by a user to play on the external computer a first content corresponding to a first computer interface signal on the USB interface by receiving the first computer interface signal on the USB interface through the USB interface according to the received demodulated video/audio signal, the decoded digital video and audio signals, and the sensed image signal.

In an embodiment, the image signal RGB_bayer is a bayer image data and has to be forwarded to the hybrid processing module 38 to be conversed into an image signal of the stand YUV format. In another embodiment, the image signal RGB_bayer has been formed as a YUV formatted signal in the sensing unit 37. Thus, the image signal RGB_bayer is a Video_YUV signal (not shown).

In an embodiment, the hybrid processing module further comprises a storage interface and the multivideo-purpose portable electronic device further comprises a storage module connected through a data/address bus to the storage interface, wherein the multivideo-purpose portable electronic device is further enabled by another command by the user to execute one of the following actions: storing the first content corresponding to a second computer interface signal on the USB interface through the data/address bus to the storage module, acquiring a second content corresponding to a third computer interface signal on the USB interface from the storage module through the storage interface onto the external computer, and playing the acquired second content corresponding to a fourth computer interface signal on the USB interface on the external computer.

By means of the multivideo-purpose portable electronic device, a user can watch a TV program received externally and get involved in a video conference/chat process concurrently, store the TV program and a record of the video conference/chat process and watch the stored TV program and the record of the video conference/chat process at different locations. Further, an application software necessary for operating the mutlivideo-purpose portable electronic device on the computer may be directly stored in the portable electronic device itself. As such, a promoted convenience and lower cost are achieved by the multivideo-purpose portable electronic device.

### BRIEF DESCRIPTION OF THE DRAWINGS

The above and other objects of the present invention will become readily apparent by reference to the following detailed description when considered in conjunction with the accompanying drawings wherein:

FIG. 1 is a block diagram illustrating how a conventional portable TV card works with a computer;

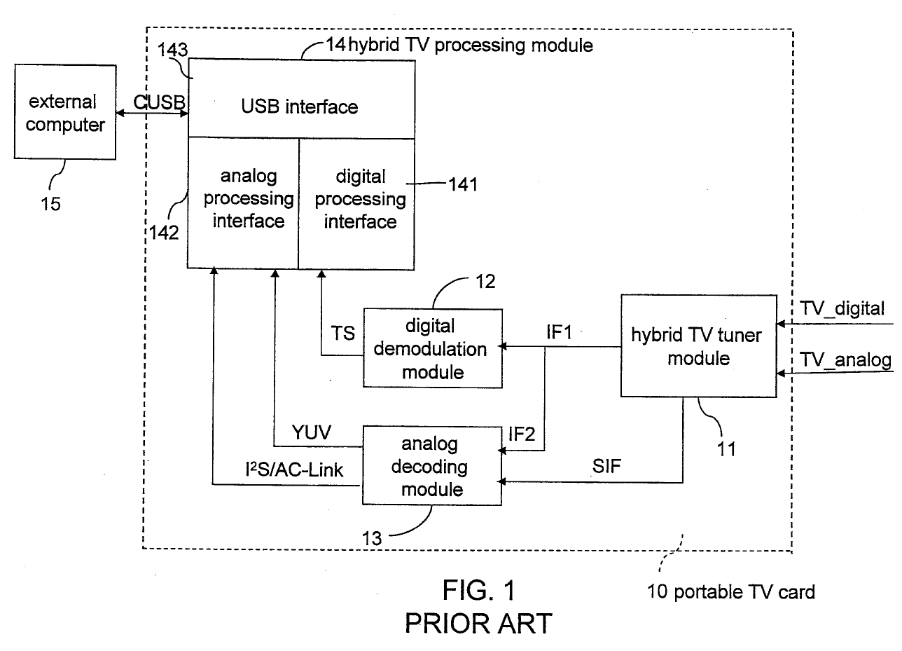

FIG. 2 is a block diagram illustrating how a conventional portable PC camera device works with a computer; and

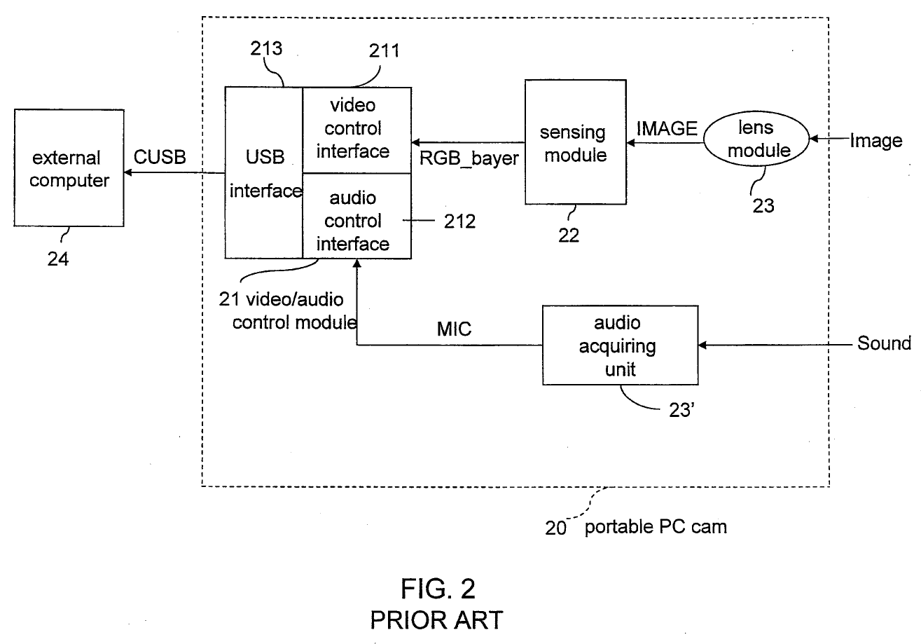

FIG. 3 is a block diagram illustrating how a multivideo-purpose portable storage device works with a computer according to the present invention.

### DETAILED DESCRIPTION OF THE INVENTION

The present invention is a multivideo-purpose portable electronic device, which can provide a TV and PC camera functions concurrently and will be described taken in the preferred embodiments with reference to the accompanying drawings.

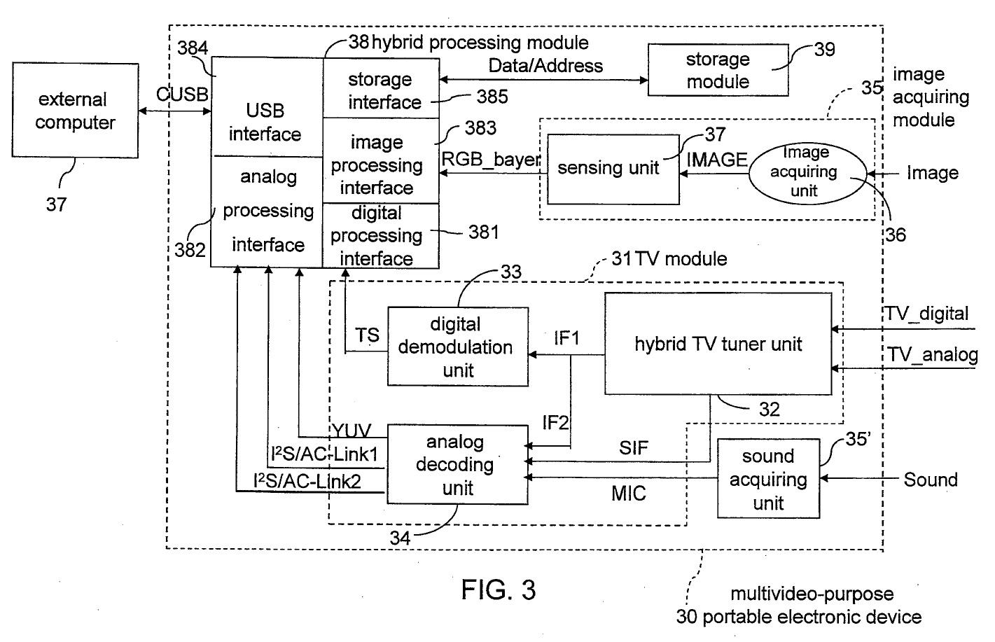

Referring to FIG. 3, the multivideo-purpose portable electronic device 30 is connected to an external computer 37 and comprises a TV module 31, an image acquiring module 35, a sound acquiring module 35′ and a hybrid processing module 38. Among them, the TV module 31 is associated with the TV function while the image acquiring module 35 and the sound acquiring module 35′ with the PC camera function. T he hybrid processing module 38 is provided to communicate both the TV and PC camera associated processings with the computer 37. The computer 37 comprises an application software (not shown) for accessing the multivideo-purpose portable electronic device 30. The application software comprises a TV portion and a chat process (or conference) portion, corresponding to an execution of the TV and PC camera functions, respectively.

In the multivideo-purpose portable electronic device 30, the TV module 31 comprises a hybrid TV tuner unit 32, a digital demodulation unit 33 and an analog decoding unit 34. Specifically, the TV module 31 further comprises an antenna (not shown) and a cable interface (not shown). The TV module 31 receives the wireless TV signal and the cable TV signal through the antenna and an external cable connected to the cable interface, respectively. The image acquiring module 35 comprises an image acquiring unit 36 and a sensing unit 37. The hybrid processing module 38 comprises a digital processing interface 381, an analog processing interface 382, an image processing interface 383 and a universal serial bus (USB) interface 384.

When a user executes a command “play” on the TV portion of the application software on the computer 37, the hybrid TV tuner unit 32 in the TV module 31 receives an external digital TV signal TV_digital or an external analog TV signal TV_analog. Each of the external digital and analog TV signals TV digital and TV_analog may be a wireless TV signal or a cabled TV signal and comprises a video signal and an audio signal. In response to the external digital or analog TV signals TV_digital and TV_analog, the hybrid TV tuner unit 32 outputs a digital video/audio signal IF1, or an analog video signal IF2 and an analog audio signal SIF.

The digital demodulation unit 33 is used to receive the digital video/audio signal IF1 and output a demodulated digital video/audio signal TS in response to the received digital video/audio signal IF1.

The analog decoding unit 34 is used to receive the analog video signal IF2 and the analog audio signal SIF, and then output a decoded digital video signal YUV in response to the analog video signal IF2 and a decoded digital audio signal I²S/AC-Link1 in response to the analog audio signal SIF.

When the user executes a command “chat” on the chat portion of the application software on the computer 37, the image acquiring unit 36 of the image acquiring module 35 receives an image Image from outside and then outputs an image signal IMAGE of the form of an electric signal to the sensing unit 37. In response, the sensing unit 37 outputs a sensed image signal RGB_bayer. In the illustrated embodiment, the image signal RGB_bayer is a bayer image signal and has to be forwarded to the hybrid processing module 38 so as to be converted to am image signal of standard YUV format.

Concurrently, the sound acquiring module 35′ receives a sound from outside and then convert the sound into an analog audio signal MIC. The analog audio signal MIC is then transmitted to the analog decoding unit 34 for decoding operation. In response, the analog decoding unit 34 outputs a decoded digital audio signal I²S/AC-Link2.

In the above, the decoded digital audio signals I²S and AC-Link1/AC-Link2 are taken from two different digital audio signal systems, respectively. Although only one of the decoded digital audio signals I²S/AC-Link1 and I²S/AC-Link2 is outputted (since only one of the “play” and “chat” commands corresponding to the TV and the PC camera functions, respectively, is executed at the application software end) in the present invention, they may each have its associated circuit disposed in the analog decoding module 34. In addition, circuits corresponding the decoded digital audio signals AC-Link1 and AC-Link2 in the TV module 31 can be shared by each other since only one of the “play” and “chat” function is executed concurrently.

No matter which one of the “play” and “chat” functions is executed at the application software end, the hybrid processing module 38 receives the demodulated digital video/audio signal TS, the demodulated digital video signal YUV, the decoded digital audio signals I²S/AC-Link1 and I²S/AC-Link2, and the sensed image signal RGB_bayer. Specifically, the demodulated video signal YUV is outputted to the digital processing interface 381. The decoded digital video signal YUV and the decoded digital audio signals I²S/AC-Link1 and I²S/AC-Link2 are outputted to the analog processing interface 382. Specifically, the demodulated digital video/audio signal TS is outputted to the digital processing interface 381. The decoded digital video signal YUV and the decoded digital audio signals I²S/AC-Link1 and I²S/AC-Link2 are outputted to the analog processing interface 382. The sensed image signal RGB_bayer is outputted to the image processing interface 383.

In response, the hybrid processing module 38 outputs a computer interface signal CUSB to the computer 37 through the USB interface 384 according to the demodulated video signal YUV, the decoded digital video signal YUV and the decoded digital audio signals I²S/AC-Link1 and I²S/AC-Link2. In this manner, since the multivideo-purpose portable electronic device 30 and the computer 37 are in communication via the CUSB signal in both video and audio components, the TV and PC camera functions of the device 30 can be executed at the computer 37 through the application software thereon. For instance, when the TV function is activated, i.e. the “play” command is sent, a TV program is played on the computer (more accurately on a display (not shown) associated with the computer) 37. On the other hand, when the PC camera function is otherwise activated, i.e. the “chat” command is sent, a series of picture frames of a video conference or chat process are displayed on the computer 37 and the user may communicate with one staying at the other end which the video content associated with the series picture frames are from. Of course, commands such as “stop” is also provided, so that the user may choose to stop the video content to be played or shown on the computer 37. Certainly, as the video component flows no matter which one of the TV and PC camera functions is activated, the audio component also accompanies.

Preferably, the multivideo-purpose portable electronic device 30 is additionally provided with a storage module 39. Specifically, the storage module 39 is connected to an additional storage interface 385 of the hybrid processing module 38 via a data/address bus Data/Address, on which a data/address signal associated with the video and audio content is transmitted. At this time, the application software on the computer 37 further has a command “store” and a command “acquire and play” for the user, so that the user may execute the command “store” to store the received video and audio content and the command “acquire and play” to acquire the video and audio content from the storage module 39 and then play the acquired video and audio content on the computer 37, through the computer interface CUSB. Although the commands “play”, “chat”, “stop”, “store” and “acquire and play” are exemplified, the exact commands may not be thus defined. All the commands equivalent to those described above should be contemplated in the present invention.

The storage module 39 may be a one inch mini hard drive or a flash memory. The flash memory 38 is integrally formed with the multivideo-purpose portable electronic device 30 while the small sized portable hard disk drive 38 is integrally formed with or detachable from the multivideo-purpose portable electronic device 30. The storage module 39 may further be a card reader and a card which can be read by the card reader. The card reader is integrally formed with or detachable from the multivideo-purpose portable electronic device 30, and the card is inserted into the multivideo-purpose portable electronic device 30 in operation. The one inch mini hard drive 38 is described as “detachable” simply because it has a standard connector and the multivideo-purpose portable electronic device 30 also comprises a standard connector complemented thereto, which the standard connector of the one inch mini hard drive 38 may be connected to or detached from. Further, the storage module 39 may also be a card reader and a card readable by the card reader. At this time, the card reader 38 is integrally formed with or detachable from the portable electronic device 30.

In addition, the application software is conventionally contained in an optical disk (not shown), so that the user may install the application software into the computer 37 by accessing the optical disk. However, the application software may be stored directly in the storage module 39 of the multivideo-purpose portable electronic device 30 in the present invention and thus do without the existence of the optical disk. At this time, if the user desires to re-install the application into the computer 37, he/she may finish the job with the aid of the storage module 39 and does not take any risk of loss of the optical disk and need to locate where the optical disk has been put or worry about if the optical disk is hard to be re-acquired. Accordingly, the use of the multivideo-purpose portable electronic device 30 is provided a good convenience.

Therefore, a user may watch a TV program from outside and have a video conference or chat process with someone remotely concurrently on any computer which the multivideo-purpose portable electronic device of the present invention is connected to, store the received TV program and content of video conference or chat process, and watch the stored TV program and the content of video conference or chat process.

The above mentioned signals TV_signal, TV_analog, IF1, IF2, TS, YUV, I²S/AC-Link1, I²S/AC-Link2, Data/Address and CUSB are apparent to those skilled in the art and will be omitted herein for clarity.

By performing the present invention, the user may execute more than one function by connecting a single portable electronic device to a computer, effectively enhancing the user convenience. In addition, the USB interfaces for the conventional portable TV card and portable PC camera and even the portable storage device are implemented as a single USB interface (i.e. the above described USB interface 384) when the conventional portable TV card and PC camera and even the portable storage device are incorporated into the multivideo-purpose portable electronic device of the present invention. Further, the hardware and firmware necessary for implementation of the conventional portable TV card and portable PC camera may be shared in the inventive multivideo-purpose portable electronic device. Moreover, the housings used for the conventional portable TV card and portable PC camera and even the portable storage device can be reduced in cost in the present invention in terms of the same TV and PC cam, and even the storage, functions.

It is readily apparent that the above-described embodiments have the advantage of wide commercial utility. It should be understood that the specific form of the invention hereinabove described is intended to be representative only, as certain modifications within the scope of these teachings will be apparent to those skilled in the art. Accordingly, reference should be made to the following claims in determining the full scope of the invention.

What is claimed is:

1. A multivideo-purpose portable electronic device, comprising:
a sound acquiring module receiving a sound from outside and outputting a first audio signal in response thereto;
a TV module, comprising:
a hybrid TV tuner unit receiving one of an external digital TV signal and an external analog TV signal each comprising a video signal and an audio signal, and outputting one of a digital video/audio signal, and an analog video signal and a second analog audio signal in response thereto;
a digital demodulation unit receiving the digital video/audio signal and outputting a demodulated digital video/audio signal in response thereto; and
an analog decoding unit receiving the analog video and first and second audio signals and outputting a demodulated digital video signal and a first and second decoded digital audio signals in response thereto, respectively;
an image acquiring module storing a data content and comprising:
an image acquiring unit acquiring an image and outputting an image signal; and
a sensing unit receiving the image signal and outputting a sensed image signal in response thereto; and
a hybrid processing module having:
a digital processing interface receiving the demodulated digital video/audio signal;
an analog processing interface receiving the demodulated digital video signal and the first and second decoded audio signal;
an image processing interface receiving the sensed image signal; and
a USB interface connected to an external computer,
wherein the multi-video/audio purpose portable electronic device is further enabled by a command by a user to play on the external computer a first content corresponding to a first computer interface signal on the USB interface by receiving the first computer interface signal from the external computer through the USB interface according to the received demodulated video/audio signal, the decoded digital video and audio signals, and the sensed image signal.

2. The multivideo-purpose portable electronic device as claimed in claim 1, wherein the external computer includes an application software comprising a TV portion associated with the TV module and a chat portion associated with the image acquiring module, and the user plays the first content on the external computer by performing the TV portion and the chat portion of the application software, respectively, and when the TV potion is activated by the command the first content is a TV program content, while when the chat portion is activated by the command the first content is a video conference/chat process content.

3. The multivideo-purpose portable electronic device as claimed in claim 1, wherein the sensed image signal is a bayer image signal.

4. The multivideo-purpose portable electronic device as claimed in claim 1, wherein each of the external digital and analog TV signals is one of a wireless TV signal and a cabled TV signal.

5. The multivideo-purpose portable electronic device as claimed in claim 4, wherein the TV module further comprises an antenna receiving the wireless TV signal and a cable interface receiving the cable TV signal through an external cable connected thereto, respectively.

6. The multivideo-purpose portable electronic device as claimed in claim 1, wherein the image acquiring unit is a lens assembly and the sound acquiring module is a microphone.

7. The multivideo-purpose portable electronic device as claimed in claim 1, wherein the hybrid processing module further comprises a storage interface and the multivideo-purpose portable electronic device further comprises a storage module connected through a data/address bus to the storage interface, wherein the multivideo-purpose portable electronic device is further enabled by another command by the user to execute one of the following actions: storing the first content corresponding to a second computer interface signal on the USB interface through the data/address bus to the storage module, acquiring a second content corresponding to a third computer interface signal on the USB interface from the storage module through the storage interface onto the external computer, and playing the acquired second content corresponding to a fourth computer interface signal on the USB interface on the external computer.

8. The multivideo-purpose portable electronic device as claimed in claim 7, wherein the external computer includes an application software comprising a TV portion associated with the TV module and a chat portion associated with the image acquiring module, and the user stores and acquires the second content and plays the stored second content by performing the TV portion and the chat portion of the application software, respectively, and when the TV potion is activated by the another command the first content is a TV program content, while when the chat portion is activated by the another command the second content is a video conference/chat process content.

9. The multi-video/audio purpose portable electronic device as claimed in claim 8, wherein the application software is stored in the storage module before being installed into the external computer.

10. The multivideo-purpose portable electronic device as claimed in claim 7, wherein the storage module is selected from the group consisting of a one inch mini hard drive and a flash memory.

11. The multivideo-purpose portable electronic device as claimed in claim 10, wherein the flash memory is integrally formed with the portable electronic device and the small sized portable hard disk drive is integrally formed with or detachable from the portable electronic device.

12. The multivideo-purpose portable electronic device as claimed in claim 11, wherein the storage module further comprises a card reader and a card readable by the card reader.

13. The multivideo-purpose portable electronic device as claimed in claim 12, wherein the card reader is integrally formed with or detachable from the multivideo-purpose portable electronic device.

14. The multivideo-purpose portable electronic device as claimed in claim 7, wherein the sensed image signal is a bayer image signal.

15. The multivideo-purpose portable electronic device as claimed in claim 7, wherein each of the external digital and analog TV signals is one of a wireless TV signal and a cabled TV signal.

16. The multivideo-purpose portable electronic device as claimed in claim 7, wherein the TV module further comprises an antenna receiving the wireless TV signal and a cable interface receiving the cable TV signal through an external cable connected thereto, respectively.

17. The multivideo-purpose portable electronic device as claimed in claim 7, wherein the image acquiring unit is a lens assembly and the sound acquiring module is a microphone.
